(19) United States
(12) Patent Application Publication
(10) Pub. No.: US 2011/0182061 A1
(43) Pub. Date: Jul. 28, 2011

(54) LANTERN WITH APERTURED TOP REFLECTOR

(75) Inventor: Byron N. Loibl, Wichita, KS (US)

(73) Assignee: THE COLEMAN COMPANY, INC., Wichita, KS (US)

(21) Appl. No.: 13/010,515

(22) Filed: Jan. 20, 2011

Related U.S. Application Data
(60) Provisional application No. 61/298,877, filed on Jan. 27, 2010.

(51) Int. Cl. F21L 19/00

(52) U.S. Cl. 362/186

(57) ABSTRACT

A portable electric lantern including a top reflector and means for allowing illumination from a light source into an upper cavity and out through a top cap.

### TECHNICAL FIELD OF THE INVENTION

The present invention is directed to lights, and more particularly to a portable electric lantern having an apertured reflector and a clear top cap for the projection of illumination in an upward direction.

### BACKGROUND OF THE INVENTION

Portable electric lanterns are useful for a variety of different applications, including use for light in the outdoors, backup lighting in a power outage, or as a source of light to find an object in a dark location or to enable a user to work in areas of low light. A drawback to conventional electric lanterns, however, is that the lantern provides illumination that projects radially outward from the lantern through the globe, but there is a “black hole” directly above the lantern where little or no illumination is projected.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In accordance with an embodiment, a electric lantern is provided. The lantern includes a clear top cap and a top reflector having apertures therein to allow illumination through the top reflector and to the top cap for projections in a direction above the lantern.

Other features of the invention will become apparent from the following detailed description when taken in conjunction with the drawings, in which:

### BRIEF DESCRIPTION OF THE DRAWINGS

FIG. 1 is a front perspective view of a lantern in accordance with an embodiment;

FIG. 2 is a top perspective view of the lantern of FIG. 1;

FIG. 3 is a fragmentary cross-section of the front view of the lantern of FIG. 1;

FIG. 4 is a back view of the lantern of FIG. 1;

FIG. 5 is a back perspective view of the lantern of FIG. 1;

FIG. 6 is a top view of the lantern of FIG. 1; and

FIG. 7 is a bottom view of the lantern of FIG. 1.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

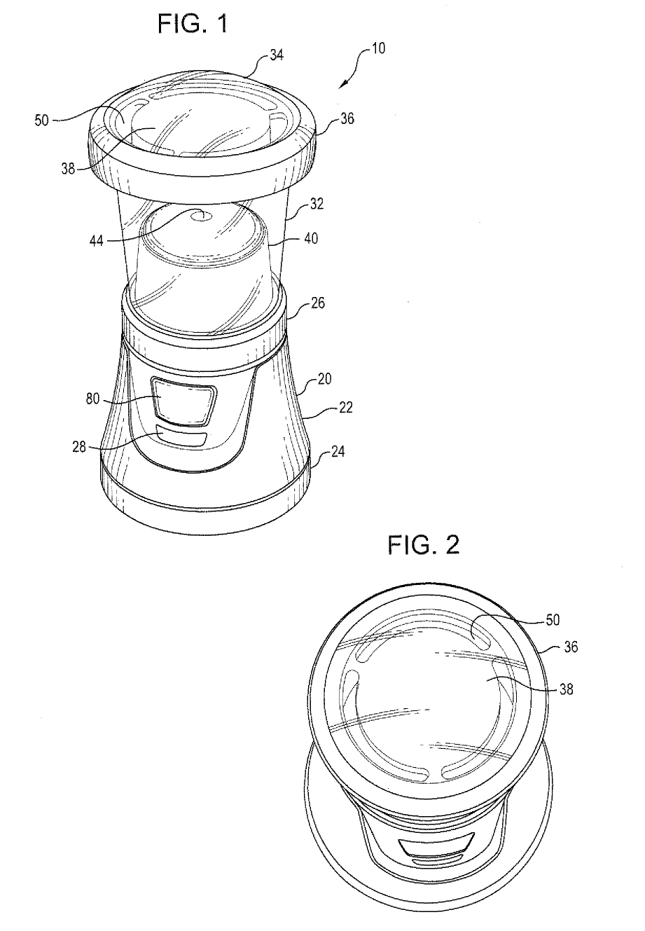

Referring now to the drawings, in which like reference numerals represent like parts throughout the several views, FIG. 1 shows a lantern 10 in accordance with an embodiment of the invention. The lantern 10 includes a housing assembly 20 and a globe assembly 30. The globe assembly comprises globe 32, translucent top cap 34, top cap sleeve 36, top reflector 38, bottom reflector 40 and light source 42.

Most illumination from the lantern is generating using the light source 42 and the bottom reflector 40 in the conventional manner. Light source 42 is located under bottom reflector 40 and projects illumination into the cavity created by globe 32 through the light source aperture 44 in bottom reflector. The majority of the illumination generated by light source 42 is projected radially outward through globe 32. Globe 32 is translucent and is preferably made of polycarbonate or a similar material known in the industry. Globe 32 may comprise a texturized surface.

Bottom reflector 40 is preferably metalized for maximum reflectance and light output. Bottom reflector 40 reflects the light generated from light source 42 outward through translucent globe 32.

Top cap 34 is translucent and is preferably made of polycarbonate or a similar material known in the industry. Top cap 34 comprises a curvilinear dome and has a cross sectional shape that compliments the shape of lantern globe 32. As shown in FIG. 1, globe 32 is preferably generally cylindrical in shape. Almost any other shape, however, such as square, triangular or the like would also fall within the scope of the present invention. In such case, the bottom reflector, and top cap would preferably be of a shape complimentary to the shape of the globe.

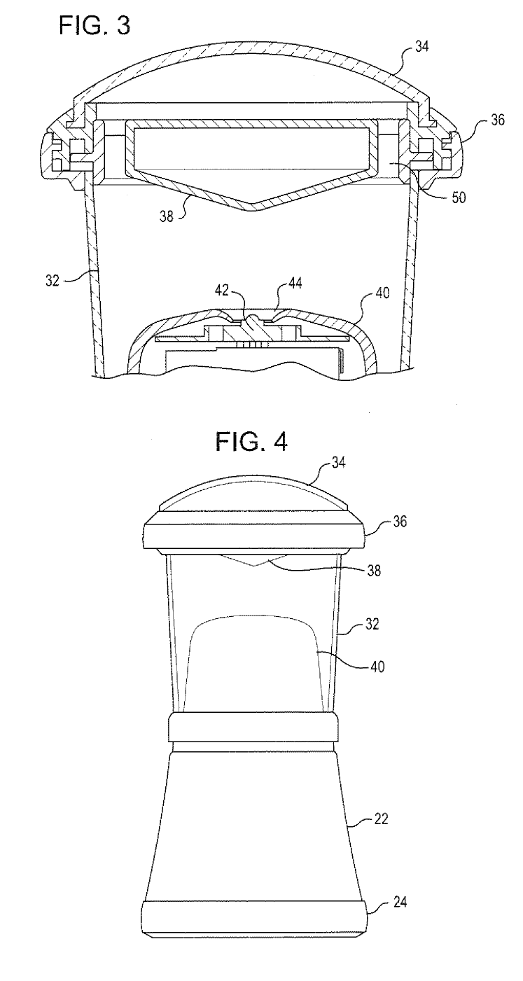

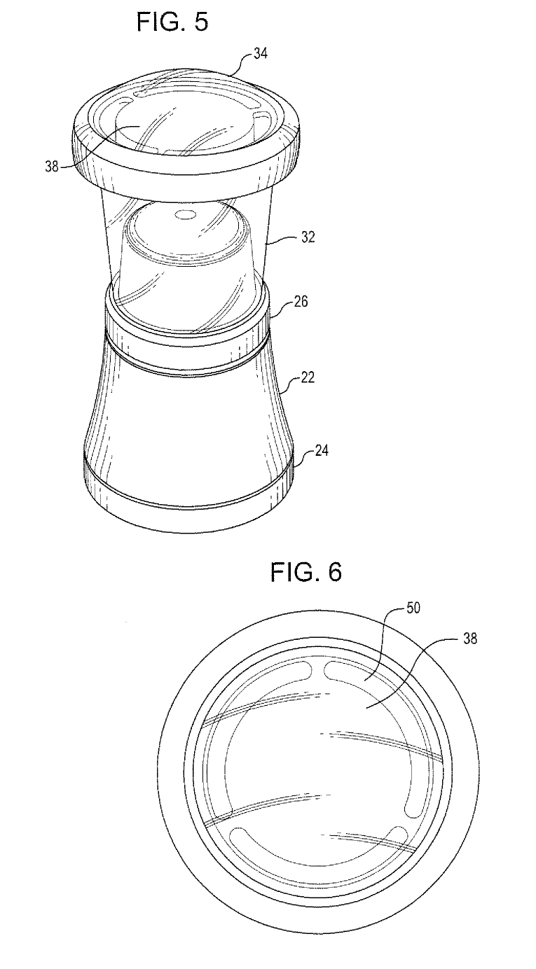

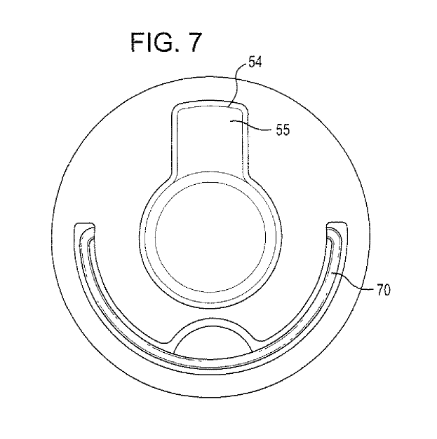

As shown in FIGS. 3 and 4, top reflector 38 is conical in shape to maximize reflectance of light generated from the light source 42 through the globe 32. Top reflector 38 is also metalized to maximize reflectance. As shown in FIGS. 2 and 3, top reflector 38 also comprises through-cuts 50 which allow illumination to exit into the area between top reflector 38 and top cap 34 and to be projected outward through translucent top cap 34. The apertures 50 in top reflector 38 operate to provide glow or illumination on the top side of lantern.

Top reflector 38 comprises three elongated slots 50 which are shaped to compliment the shape of top reflector 38. Although three slots 50 are depicted herein, it is within the scope of the present invention for top reflector 38 to comprise any number of apertures in any size, shape, location and/or orientation on top reflector provided that the overall surface area of top reflector is sufficiently maintained so as to provide adequate reflectance for the generated light. By way of a non-limiting examples, it is within the scope of the present invention for apertures 50 to comprise a multitude of circular apertures in a repeating pattern over the top surface of top reflector or for apertures 50 to comprise slots radiating outward from the center of top reflector like the spokes of a wheel.

Housing assembly 20 comprises base 22, base sleeve 24, upper base sleeve 26 and battery power meter 28. The lantern 10 also includes internal wiring (not shown) and a power switch 80 to allow a user to turn the light off and on using the switch. Base 22 includes bail hook 70 that is pivotally attached to the underside of base 22 to enable lantern 10 to be hung in an upside down orientation.

Receptacle 54 is located on the underside of housing assembly 20 defining a cavity for receiving an interchangeable power pack 55, as shown in FIG. 7. Preferably, the power pack 55 may be powered with batteries, rechargeable batteries, fuel cells and the like. It is also within the scope of the present invention for receptacle 54 to receive batteries (not shown) that may be mounted therein and secured with a bottom cap (not shown).

Light source 42 may include any form of lamp, including a light emitting diode (LED), halogen lamp, an incandescent lamp, a fluorescent lamp, or other lamps or lights.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A lantern, comprising:
a housing;
a power source mounted in the housing;
a globe mounted on the housing, defining a cavity thereon;
a bottom reflector mounted within the globe;
a light source mounted within the globe;
a translucent cap mounted on top of the globe, sealing the cavity;
a top reflector located under the cap, within the cavity; and
wherein the top reflector comprises apertures therein allowing for illumination from the light source to pass through apertures and project through cap.

2. The lantern of claim 1, wherein the top reflector comprises three slots positioned around the perimeter of top reflector.

3. The lantern of claim 1, wherein the power source comprises an interchangeable power pack.

4. A lantern, comprising:
a housing;
a power source mounted in the housing;
a globe mounted on the housing;
a bottom reflector;
a light source;
a top cap defining a cavity therein;
a top reflector located within the cavity; and
means for allowing illumination from the light source to pass through the top reflector into the top cap cavity.
